(19) United States
(12) Patent Application Publication
(10) Pub. No.: US 2012/0182573 A1
(43) Pub. Date: Jul. 19, 2012

(54) PRINT SUPPORT APPARATUS, PRINTING SYSTEM AND PRINT SUPPORT PROGRAM

(75) Inventor: Chun Ho Michael MOK, Kawasaki-shi (JP)

(73) Assignee: KONICA MINOLTA BUSINESS TECHNOLOGIES, INC., Tokyo (JP)

(21) Appl. No.: 13/338,901

(22) Filed: Dec. 28, 2011

(30) Foreign Application Priority Data
Jan. 13, 2011 (JP) 2011-005067

(51) Int. Cl. G06F 3/12

(52) U.S. Cl. 358/1.15

(57) ABSTRACT

Disclosed is a print support apparatus that makes it possible even for a client, who has no document creation/editing application program and no printer driver, to implement a printing operation easily and safely by employing the SaaS. The print support apparatus, which is to be installed in a user's inhouse network being connectable to the Internet, includes: a detecting section to detect a printer coupled to the user's inhouse network; a notifying section to notify a print service server of information for specifying the printer above-detected; an acquiring section that accesses a predetermined storing destination site, in which print data created from document data by the print service server by executing a printer driver corresponding to the printer above-detected, is stored, so as to acquire the print data from the predetermined storing destination site concerned; and a data transferring section to transfer the print data to the printer above-detected.

This application is based on Japanese Patent Application NO. 2011-005067 filed on Jan. 13, 2011, with Japan Patent Office, the entire content of which is hereby incorporated by reference.

### BACKGROUND OF THE INVENTION

The present invention relates to a print support apparatus, a printing system and a print support program, and specifically relates to such a print support apparatus, a printing system and a print support program that respectively make it possible to conduct a printing operation requested by a client terminal device into which no printer driver is installed.

Conventionally, when creating a document to be printed onto a paper sheet, the user employs a document creation/editing application program installed in advance into a computer apparatus so as to create the document concerned, and then, selects a desired printer driver from the printing menu provided in the document creation/editing application program concerned, to issue a printing command.

The document data, created by using the document creation/editing application program, is transferred to the printer driver through a standard interface of an OS (Operating System). Receiving the document data, the printer driver converts the document data to print data written in the Page Description Language. Successively, the print data is transmitted to the printer coupled to the computer apparatus, and then, the concerned printer applies the rendering processing, etc., to the print data, so as to print an image, represented by the print data, onto the paper sheet.

In the abovementioned printing mode, it has been indispensable that the document creation/editing application program and the printer driver are installed in advance into the computer apparatus concerned. Accordingly, sometimes, it has been impossible for the user to implement the printing operation in such an apparatus into which the document creation/editing application program and the printer driver have not been installed yet, resulting in an inconvenience for the user.

On the background as abovementioned, in recent years, another software using mode called the SaaS (Software as a Service) has emerged in the market concerned. Since the SaaS provides the user with such a service that the server owned by the provider on the Internet executes the concerned application programs serving as software, so as to implement the processing requested by the user and to send back the processed result to the user, it becomes unnecessary for the user to purchase the software concerned and to nm the maintenance operations thereof. In addition, the introduction cost for the software can be reduced, since the using charge is to be paid every time when using the service concerned.

In order to use the application program in the SaaS mode abovementioned, the user accesses the portal site of the service provider that provides the application program in the SaaS mode, with using a Web browse. Successively, the user request the portal site to execute the application program concerned so as to implement the processing desired by the user, and then, confirms the processing result on the Web browser. Accordingly, there has been such a merit in the SaaS mode that, even if the user possesses such a mobile terminal device that has merely a low-grade calculation efficiency, such as a smart-phone, a PDA (Personal Digital Assistants), a tablet-type computer, etc., it is possible for the concerned user to use the application program in the SaaS mode, as far as the Web browse is installed in the mobile terminal device concerned and the Internet connection environment is provided.

In the configuration described in the above, it is important to acquire information necessary for the communications between an external network and an internal network, and there have been proposed various kinds of methods for acquiring the information concerned. For instance, Tokkai 2004-272632 (Japanese Patent Application Laid-Open Publication) sets forth such the technical method that the information processing apparatus, serving as an application program gateway coupled to the border between the external network and the internal network, implements the server information acquisition processing in regard to the server coupled through the internal network, under the condition that the information processing apparatus has received the request of acquiring the server information of the server coupled to the internal network, and then, creates the delivery list based on the server information, so as to transmit the created delivery list to the client terminal device through the external network.

Further, Tokkai 2005-306718 (Japanese Patent Application Laid-Open Publication) sets forth such the technical method that, in order to make a device (for instance, a camera) in an internal network accessible from a client (user of the service) in an external network, the management apparatus is installed in the system, so that the management apparatus retrieves a specific device from the devices installed in the internal network to allot identification information (port number) to the specific device retrieved, and then, establishes the allotted identification information into the router, and, notifies the external client of the port number and the identifier (global IP address) of the external network side of the router concerned, so as to make the external client accessible to the internal device according to the information above-mentioned.

According to the printing mode in which a document is printed onto a paper sheet by operating such the computer apparatus into which the document creation/editing application program is installed, the printer driver and the physical printer are controlled on the OS as a relationship of one for one. Accordingly, the document creation/editing application program that has been employed for creating the document data concerned is also employed for acquiring the printer information from the OS so as to make the user select desired one of the printers provided, and as a result, the document data is transferred to the printer driver for the desired one of the printers, designated (selected) by the user, through the OS. Successively, the concerned printer driver converts the document data to the print data, and then, transmits the print data to the printer, so as to make the printer implement the printing operation according to the print data.

On the other hand, according to the other printing mode (SaaS printing mode) in which a document is printed onto a paper sheet by employing the SaaS service, although the processing in charge of the document creation/editing application program and the printer driver are to be implemented in the server side that provides the SaaS service, the physical printer, operations of which are to be conjunction with the printer driver concerned, is located at the user's side as well as the conventional system, and therefore, the printer driver hardly acquires information in regard to the physical printer. As a result, it is impossible for the printer driver to transfer the printer information, being available for the user, back to the document creation/editing application program. In addition, even if the printer driver could receive the document data concerned, since the printer driver has no information in regard to the physical printer, it is also impossible for the printer driver to convert the document data to appropriate print data.

Accordingly, in the latter mode (SaaS printing mode), it is necessary to provide the server, which provides the SaaS service, with the printer information. In this connection, generally speaking, since the network provided in the user's side (hereinafter, referred to as a user's network) is a private network, a sub-network, or the like, the user's network should be coupled through the router in order to connect the user's network to the Internet, and generally, a Firewall policy is established in the concerned router for the security sake. However, since the general purpose Firewall policy is so established that, the forward connecting request, in regard to the forward communication from a node on the user's network (such as a personal computer, a network apparatus, a network printer, etc.) to a computer on the Internet (such as a Web server, a mail server, etc.), is allowed, while the reverse connecting request, in regard to the reverse communication from the computer on the Internet to the node on the user's network, is shut off, it is quite difficult for the server, currently operated on the SaaS system, to directly acquire the printer information in regard to the physical printer on the user's network.

To cope with the abovementioned problem, as set forth in Tokkai 2004-272632 cited in the above, although it could be considered such a configuration that the management apparatus, equipped at the border between the external network and the internal network, accepts the request issued from the external network, so as to send the information in regard to the internal network back to the client terminal device on the external network, serving as the requester, according to such the configuration, it is necessary to change the router settings. Further, as set forth in Tokkai 2005-306718 cited in the above, although it could be also considered such a configuration that the port number allotted to the router is made to be opened, so as to allow the reverse connection request issued from the external network, even in such the configuration, it is necessary to change the router settings, and, since the port is opened, the security aspect of the concerned system would be degraded.

Accordingly, in order to create a document to be printed on a paper sheet by employing the SaaS service, it is necessary to provide such a structural system that makes it possible to provide the document creation/editing application program and the printer driver, which are to be run on the SaaS system, with the information of the physical printer currently residing at the user's side. Further, it is also necessary to provide such a structural system that makes it possible to transmit the print data from the SaaS printer driver to the physical printer currently residing at the user's side.

### SUMMARY OF THE INVENTION

To overcome the abovementioned drawbacks in conventional printing systems, it is one of objects of the present invention to provide a print support apparatus, a printing system and a print support program, each of which makes it possible even for a client, who has no document creation/editing application program and no printer driver, to implement a printing operation easily and safely by employing the SaaS.

Accordingly, at least one of the objects of the present invention can be attained by any one of the print support apparatus, a printing system and a print support program, described as follows.

(1) According to a print support apparatus reflecting an aspect of the present invention, the print support apparatus that is to be installed in a user's inhouse network being connectable to the Internet, comprises: a detecting section to detect a printer coupled to the user's inhouse network; a notifying section to notify a print service server, provided with a printer driver function, of information for specifying the printer detected by the detecting section; an acquiring section that accesses a predetermined storing destination site, in which print data created from document data by the print service server by executing a printer driver corresponding to the printer detected by the detecting section, is stored, so as to acquire the print data from the predetermined storing destination site concerned; and a data transferring section to transfer the print data, acquired by the acquiring section, to the printer detected by the detecting section.

In an embodiment of the print support apparatus as described in the above, it is desirable that hardware of each of the detecting section, the notifying section, the acquiring section and the data transferring section is constituted by a controlling section, which includes a CPU (Central Processing Unit), a RAM (Random Access Memory) and a ROM (Read Only Memory), and a communication interface.

(2) According to a printing system reflecting another aspect of the present invention, the printing system, comprises: a print service server that is provided with a printer driver function; and a user's inhouse network that is provided with a printer and a print support apparatus, and that is coupled to the print service server through the Internet; wherein the print service server creates print data from document data by executing a printer driver corresponding to the printer, so as to store the print data above-created into a predetermined storing destination site; and wherein the print support apparatus comprises: a detecting section to detect the printer coupled to the user's inhouse network; a notifying section to notify a print service server of information for specifying the printer detected by the detecting section; an acquiring section that accesses the predetermined storing destination site so as to acquire the print data therefrom; and a data transferring section to transfer the print data acquired by the acquiring section to the printer detected by the detecting section.

In an embodiment of the printing system as described in the above, it is desirable that hardware of the storage section, provided in the print service server and serving as the predetermined storing destination site, is constituted by a controlling section, which includes a CPU (Central Processing Unit), a RAM (Random Access Memory) and a ROM (Read Only Memory). Further, it is desirable that hardware of each of the detecting section, the notifying section, the acquiring section and the data transferring section, which are provided in the print support apparatus, is constituted by a controlling section, which includes a CPU, a RAM and a ROM, and a communication interface.

(3) According to a printing system reflecting still another aspect of the present invention, the printing system, comprises: a document creation/editing service server that makes it possible for a user to create document data on a Web browser; a print service server that is provided with a printer driver function; and a user's inhouse network that is provided with a client terminal device, a printer and a print support apparatus; wherein the document creation/editing service server, the print service server and the user's inhouse network are coupled to each other through the Internet and wherein the print service server comprises: a printer-information notifying section to notify the document creation/editing service server of information for specifying the printer coupled to the user's inhouse network; a data acquiring section to acquire the document data and the information for specifying the printer selected from plural printers, which are coupled to the user's inhouse network, from the document creation/editing service server; and a print-data creation/storing section that creates print data from the document data by executing a printer driver corresponding to the printer selected, so as to store the print data into a predetermined storing destination site; and wherein the print support apparatus comprises: a detecting section to detect the printer coupled to the user's inhouse network; a notifying section to notify the print service server of the information for specifying the printer detected by the detecting section, through the Internet an acquiring section that accesses the predetermined storing destination site, so as to acquire the print data, created from the document data by executing the printer driver corresponding to the printer selected, from the predetermined storing destination site; and a data transferring section to transfer the print data acquired by the acquiring section to the printer selected.

In an embodiment of the printing system as described in the above, it is desirable that hardware of each of the printer-information notifying section and the data acquiring section, which are provided in the print service server, is constituted by a controlling section, which includes a CPU (Central Processing Unit), a RAM (Random Access Memory) and a ROM (Read Only Memory). Further, it is desirable that hardware of the storage section, provided in the print service server and serving as the predetermined storing destination site, is constituted by a controlling section, which includes a CPU, a RAM and a ROM. Still further, it is desirable that hardware of each of the detecting section, the notifying section, the acquiring section and the data transferring section, which are provided in the print support apparatus, is constituted by a controlling section, which includes a CPU, a RAM and a ROM, and a communication interface.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating an overall configuration of a printing system, embodied in the present invention;

FIG. 2 shows a sequential chart indicating operations (activation processing of a print support apparatus) to be conducted in a printing system, embodied in the present invention;

FIG. 3 shows a schematic diagram indicating an agent management table to be stored in an SaaS print service, embodied in the present invention;

FIG. 4 shows a sequential chart indicating operations (detecting and notifying processing for a new printer) to be conducted in a printing system, embodied in the present invention;

FIG. 5 shows a schematic diagram indicating a printer management table to be stored in an agent apparatus, embodied in the present invention;

FIG. 6 shows a schematic diagram indicating a printer detailed information table to be stored in an agent apparatus, embodied in the present invention;

FIG. 7 shows a flowchart indicating an ONLINE notification determination processing to be conducted in a printing system, embodied in the present invention;

FIG. 8 shows a schematic diagram indicating a printer information table to be stored in a SaaS print service, embodied in the present invention;

FIG. 9 shows a sequential chart indicating operations (processing for providing an SaaS document creation/editing application with printer information) to be conducted in a printing system, embodied in the present invention;

FIG. 10 shows a sequential chart indicating operations (processing, conducted by a user, for issuing a printing command) to be conducted in a printing system, embodied in the present invention;

FIG. 11 shows a sequential chart indicating operations (processing for transmitting print data to a printer) to be conducted in a printing system, embodied in the present invention;

FIG. 12 shows a flowchart indicating a processing for detecting a printer during an ONLINE state of user's side, to be conducted in a printing system embodied in the present invention;

FIG. 13 shows a flowchart indicating an OFFLINE notification determination processing to be conducted in an agent apparatus, embodied in the present invention;

FIG. 14 shows a schematic diagram indicating an overall configuration of another printing system, embodied in the present invention; and

FIG. 15 shows a sequential chart indicating operations (processing for providing an SaaS document creation/editing application with printer information by employing an external user authentication service) to be conducted in a printing system, embodied in the present invention.

### DETAILED DESCRIPTION OF THE PREFERRED EMBODIMENT

As described in the “BACKGROUND OF THE INVENTION”, when the printing operation is conducted by employing the SaaS service, the document data is created in the service provider side, and then, the print data, converted from the document data, is transmitted to the printer coupled to the user's network. In this connection, in order to generate print data being printable by the physical printer provided in the user's side, it is necessary for the SaaS print service server to select an appropriate printer driver. However, since the SaaS print service server hardly acquires information in regard to the physical printer provided in the user's side, it is impossible to select the appropriate printer driver, and as result, it is impossible for the SaaS print service server to generate the print data concerned.

Accordingly, in the abovementioned printing mode (SaaS printing mode), it is necessary for the service provider to acquire information in regard to the printer coupled to the user's network. However, since, according to the general purpose Firewall policy, the accessing action from the service provider is rejected by the printer provided in the user's side, it should be necessary for the service provider side to change the settings of the muter and to open the port, in order to make it possible to access the concerned printer from the service provider, resulting in degradation of the security aspect.

To overcome such the drawback in conventional systems, the SaaS printing system, embodied in the present invention, is so constituted that an agent apparatus is newly coupled to the user's network, so that the agent apparatus acquires the information in regard to the printer coupled to the user's network, and provides the service provider with the information of the printer above-acquired. As a result, it becomes possible to implement the printing operation without performing complicated operations and without deteriorating the security grade.

Referring to the drawings, the SaaS printing system, embodied in the present invention, will be detailed in the following.

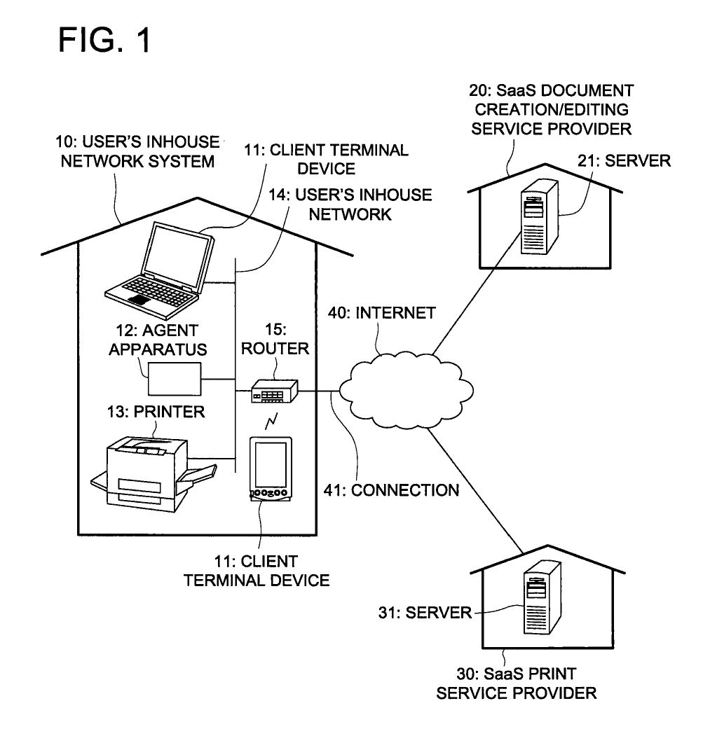

FIG. 1 shows a schematic diagram indicating an overall configuration of a printing system, embodied in the present invention. The printing system, embodied in the present invention, is constituted by a user's inhouse network system 10, an SaaS document creation/editing service provider 20 and an SaaS print service provider 30, which are coupled to each other through the Internet 40.

The user's inhouse network system 10 includes a user operating apparatus to issue a printing command (hereinafter, referred to as a client terminal device 11), a print supporting apparatus (hereinafter, referred to as an agent apparatus 12) and a printer 13, which are coupled to a user's inhouse network 14. Generally speaking, since the user's inhouse network 14 is structured as either a private network or a sub-network, a router 15 to connect the user's inhouse network 14 with the Internet 40 is provided. Although various kinds of methods, such as using an optical fiber network, using an ADSL (Asymmetric Digital Subscriber Line), etc., can be employed for connecting the router 15 with the Internet 40, the scope of the present invention is not limited to a specific method. In this connection, although the agent apparatus 12 is configured as hardware hereinafter in the present embodiment, it is also applicable that the agent apparatus 12 is configured as software, which performs the same functions as those of the agent apparatus 12 configured as hardware.

The client terminal device 11, for which various kinds of services to be provided by the service provider through the Web browser are available, (for instance, a personal computer, a mobile terminal device, a PDA, etc.) is constituted by a control section, a communication interface section, a display section, an operating section, etc. The control section is constituted by a CPU (Central Processing Unit), various kinds of storage devices including a ROM (Read Only Memory), a RAM (Random Access Memory), etc., an HDD (Hard Disc Drive) as needed, etc., so as to control the overall operations of the client terminal device 11. The communication interface section is constituted by a NIC (Network Interface Card), a modem, etc., so as to couple the client terminal device 11 to the user's inhouse network 14. The display section is constituted by an LCD (Liquid Crystal Display) device, an Organic EL (electroluminescence) display device, etc., so as to display a Web browser screen, from which the user can use the SaaS document creation/editing service and the SaaS print service, thereon. The operating section is constituted by a mouse, a keyboard, a touch panel, etc., so as to make it possible for the user to conduct various kinds of operations for using the SaaS document creation/editing service and the SaaS print service, therefrom.

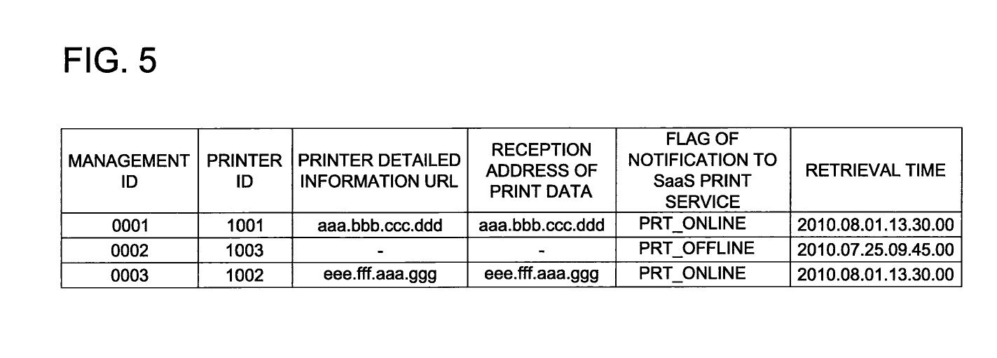

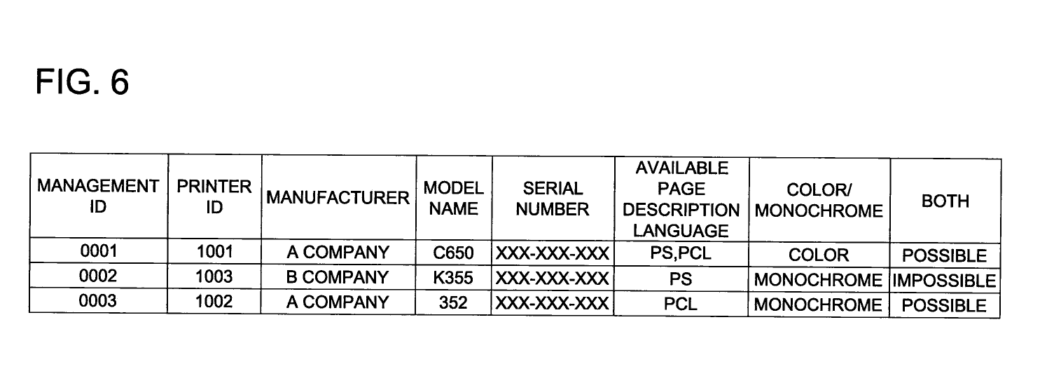

The agent apparatus 12, structured as hardware, is constituted by a control section, a communication interface section, etc. The control section is constituted by a CPU (Central Processing Unit), various kinds of storage devices including a ROM (Read Only Memory), a RAM (Random Access Memory), etc., an HDD (Hard Disc Drive) as needed, etc., so as to control the overall operations of the agent apparatus 12. In addition, the control section also conducts controlling operations for providing the SaaS print service with the information of the printer 13 installed in the user's inhouse network system 10, and for transferring the print data, acquired from the SaaS print service, to the printer 13. Various kinds of information, including information necessary for communications with the SaaS print service (for instance, a URL (Uniform Resource Locator) of the server that provides the SaaS print service, an IP address of its own, another IP address of the router 15 and still another IP address of the DNS (Domain Name Server)), a table in which information sets respectively corresponding to the printers 13 provided in the user's inhouse network system 10 are described (PRINTER MANAGEMENT TABLE shown in FIG. 5 and PRINTER DETAILED INFORMATION TABLE shown in FIG. 6), etc., are stored in the various kinds of storage devices and/or the HDD. The communication interface section is constituted by a MC (Network Interface Card), a modem, etc., so as to couple the agent apparatus 12 to the user's inhouse network 14.

The printer 13 is constituted by a control section, a communication interface section, a display operating section, an image processing section, a print processing section, etc. The control section is constituted by a CPU (Central Processing Unit), various kinds of storage devices including a ROM (Read Only Memory), a RAM (Random Access Memory), etc., an HDD (Hard Disc Drive) as needed, etc., so as to control the overall operations of the printer 13 serving as an image forming apparatus. In addition, the control section also conducts controlling operations for providing the agent apparatus 12 with the information of its own (including a printer ID (identification), a name of manufacturer, a name of model, a serial number, an corresponding Page Description Language, a kind of color/monochrome, etc.). Various kinds of programs and data (for instance, the information abovementioned, print data, image data processed in the image processing section, etc.) are stored into the storage devices and the HDD. The communication interface section is constituted by a MC (Network Interface Card), a modem, etc., so as to couple the printer 13 to the user's inhouse network 14. The display operating section is constituted by a display section, such as an LCD (Liquid Crystal Display) device, an Organic EL (electroluminescence) display device, etc., and is provided with a touch panel formed on the display section by arranging transparent electrodes in a lattice pattern, so as to make it possible to input various kinds of settings and instructions therefrom. The image processing section pareses the print data, and rasterize each page of the print data so as to create image data for every page of the document, and as needed, applies various kinds of image processing (such as a color adjustment processing, a density adjustment processing, a size adjustment processing, etc.) and/or a screening processing to the image data concerned. Successively, the print processing section converts the image data to printable image data. The print processing section is constituted by such the structural elements that are necessary for performing the image forming operations employing the image forming process based on the electrophotographic method, the electrostatic recording method, etc., so as to print the print image, represented by the image data created by the image processing section, onto the paper sheet designated in the setting information.

The router 15 is constituted by a control section, a communication interface section, etc. The control section is constituted by a CPU (Central Processing Unit), various kinds of storage devices including a ROM (Read Only Memory), a RAM (Random Access Memory), etc., so as to control the overall operations of the router 15. The communication interface section connects the client terminal device 11 and agent apparatus 12, both coupled to the user's inhouse network 14, with the Internet 40.

The SaaS document creation/editing service provider 20 is provided with a single or a plurality of server(s) 21, each of which provides the SaaS document creation/editing application program and is constituted by a control section, a communication interface section, etc. The control section is constituted by a CPU (Central Processing Unit), various kinds of storage devices including a ROM (Read Only Memory), a RAM (Random Access Memory), etc., an HDD (Hard Disc Drive) as needed, etc., so as to control the overall operations of the server 21, and provides the user with the service employing the SaaS document creation/editing application program. The storage devices or the HDD stores the document data, etc., which have been created by using the document creation/editing application program, therein. The communication interface section is constituted by a NIC (Network Interface Card), a modem, etc., so as to couple the server 21 to the Internet 40.

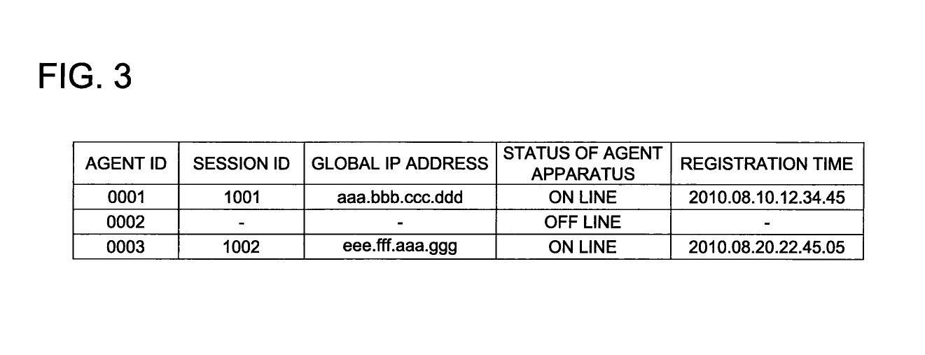

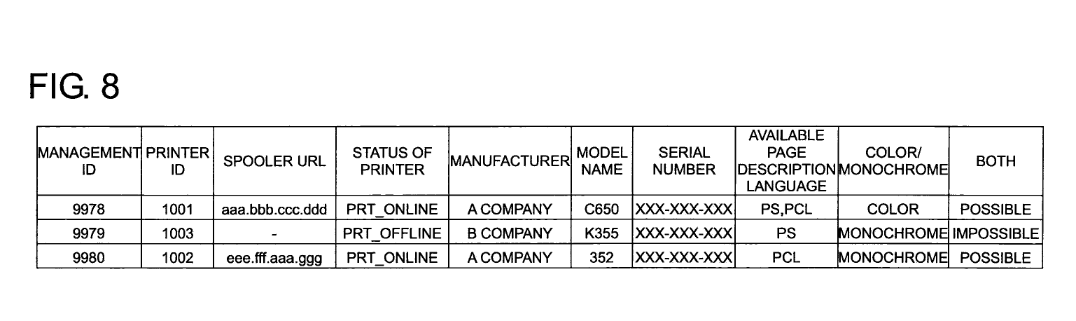

The SaaS print service provider 30 is provided with a single or a plurality of server(s) 31, each of which provides the SaaS print service and is constituted by a control section, a communication interface section, etc. The control section is constituted by a CPU (Central Processing Unit), various kinds of storage devices including a ROM (Read Only Memory), a RAM (Random Access Memory), etc., an HDD (Hard Disc Drive) as needed, etc., so as to control the overall operations of the server 31, and provides the SaaS document creation/editing application program with the information of the printer 13 installed at the user's side. In addition, the control section is also provided with the function of the printer driver and the management function for managing the printer 13 installed in the user's side. The storage device or the HDD stores various kinds of programs and data, including printer driver application programs respectively corresponding to the various kinds of printers, a table in which information acquired from the agent apparatus 12 is described (“AGENT MANAGEMENT TABLE” shown in FIG. 3, “PRINTER INFORMATION TABLE” shown in FIG. 8), document data acquired from the SaaS document creation/editing application program, print data created by using the printer driver function, etc., therein. The communication interface section is constituted by a MC (Network Interface Card), a modem, etc., so as to couple the printer 31 to the Internet 40.

In this connection, the printing system shown in FIG. 1 is merely an exemplified one of various printing systems embodied in the present invention. Accordingly, it is possible for a person having a ordinary skill in the art to change or modify the configuration or the controlling method of the printing system, shown in FIG. 1, without departing from the spirit and scope of the invention. For instance, although the SaaS document creation/editing service provider 20 and the SaaS print service provider 30 are separately installed in the printing system shown in FIG. 1, it is also applicable that the printing system is so constituted that a single server provides the user with the services to be provided by both of them. Further, although the agent apparatus 12 is an independent apparatus in the printing system shown in FIG. 1, it is also applicable that the printing system is so constituted that the functions of the agent apparatus 12 are to be performed by any one of the client terminal device 11, the printer 13 and the router 15, as either software or hardware.

Next, the rough operations to be conducted in the printing system having the abovementioned configuration will be described in the following.

The agent apparatus 12 always conducts operations for detecting and monitoring the printer 13 installed in the user's inhouse network 14, during a period from the time of its activation to the time of its deactivation, so as to notify the server 31, which provides the SaaS print service, of the information of the printer 13 managed by the agent apparatus 12. In this connection, the invariant information of the server 31 serving as a notifying destination apparatus, such as the URL of the substrate 31, the agent ID, etc., is stored into the storage device, the HDD, etc., at the time of factory default setting operation for the agent apparatus 12. On the other hand, the information depending on the installation site, such as the IP address of the agent apparatus 12 itself, the other IP address of the muter 15, still the other IP address of the DNS, etc., is established by the manager or the user, or by employing an automatic network setting function (such as the DHPC (Dynamic Host Configuration Protocol), etc.) at the time when the agent apparatus 12 has been installed in the user's inhouse network 14, and then, the established information is stored in the storage device or the HDD, etc.

The server 31 that provides the SaaS print service internally manages the information, in regard to the printer 13 in the user's inhouse network system 10 and notified from the each of the agent apparatuses 12, so as to provide the server 21 that provides the SaaS document creation/editing service, with the concerned information. When receiving the instruction for implementing the operation for printing the document created by employing the SaaS document creation/editing application program, the server 21 acquires the information of the printer 13 managed by the agent apparatus 12 installed in the user's inhouse network system 10 to which the client terminal device 11 belongs, and makes the user select the printer 13 to be employed for printing the document, so as to provide the server 31 with the created document data and the information in regard to the printer 13 selected by the user. Based on the printer driver corresponding to the printer 13 selected in the above, the server 31 converts the created document data to the print data written in the Page Description Language, and transmits the print data in response to the acquisition request sent from the agent apparatus 12.

The agent apparatus 12 transmits the print data acquired from the server 31 to the printer 13 selected by the user, so that the printer 13 implements the printing operation based on the print data concerned.

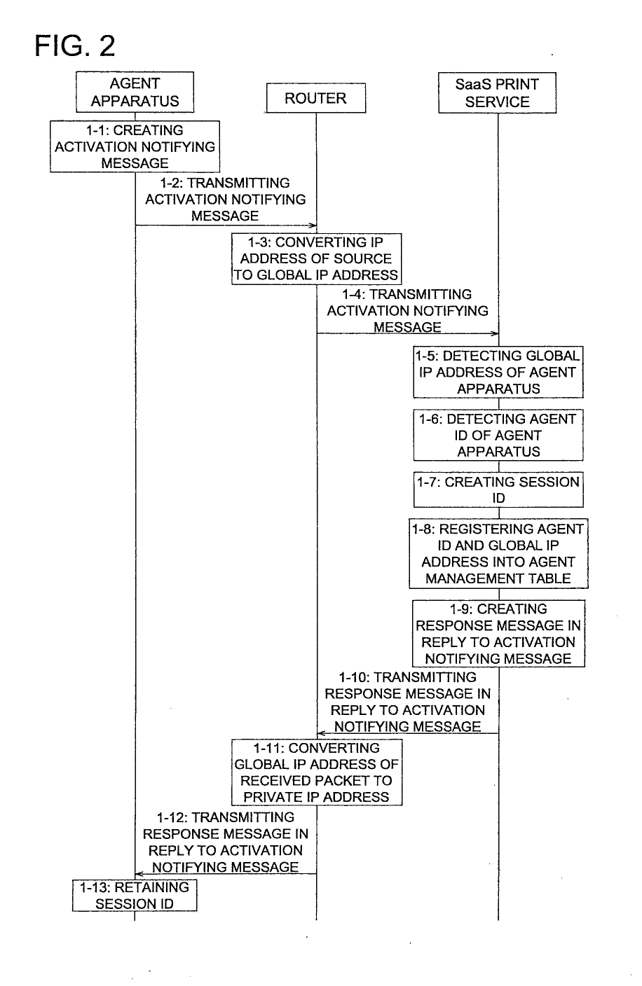

The detailed operations of the printing system will be separately described in the following. At first, referring to the sequential chart shown in FIG. 2, the activation processing of the agent apparatus 12 will be detailed in the following.

At the time when the power source turns ON, or after the reboot processing has commenced, the agent apparatus 12 creates an activation notifying message by using information, including the agent ID stored at the factory default setting operation, the time information, etc. (refer to 1-1). Successively, the server 21 transmits the activation notifying message, created in the above, to the server 31 that provides the SPAS printer service (hereinafter, referred to as the SaaS print service, for simplicity) (refer to 1-2). The address of the activation notifying message is set as the URL of the SaaS print service, and the URL is converted to the IP address by employing the well-known technology, and by using the DNS function installed in the router concerned and/or the external DNS.

In this connection, as aforementioned, since the user's inhouse network is a private network, etc., a packet (communication data), as it is, cannot be transferred through the Internet 40. Accordingly, the router 15 once converts the IP address of the sender, who intends to transmit the packet concerned, to the Global IP address being available in the Internet 40 (refer to 1-3). This function is generally called the NAT (Network Address Translation). Successively, the router 15 transmits the activation notifying message, converted to the Global IP address, to the SaaS print service through the Internet 40 (refer to 1-4).

Receiving the activation notifying message, the SaaS print service detects the Global IP address of the agent apparatus 12 serving as the sender of the packet concerned (refer to 1-5), and detects the agent ID from the contents of the packet concerned (refer to 1-6). By correlating the agent ID, detected in this step, with the Global IP address detected in Step 1-5, it is possible to determine which user's inhouse network system 10 the agent apparatus 12 is installed in.

Recognizing the agent apparatus 12 based on the information acquired in Step 1-5 and Step 1-6, the SaaS print service creates a session ID, in order to manage the connection with the agent apparatus 12 concerned as a session (refer to 1-7). Since different session IDs are respectively allotted to agent apparatuses 12, none of agent apparatus 12 has a duplicated session ID overlapping with that of the other agent apparatus 12.

Next, the SaaS print service registers the information, acquired in Step 1-5 through Step 1-7, into a agent management table (refer to 1-8). As shown in FIG. 3, the agent management table includes the agent ID, the session ID, the Global IP address, the status of the agent, the registration time, etc., so that the SaaS print service can manage the agent apparatuses 12 by referring to this agent management table.

Successively, when normally completing the operation for registering the information of the agent apparatus 12 into the agent management table, the SaaS print service creates a response message in reply to the activation notifying message sent from the agent apparatus 12 (refer to 1-9), and transmits the response message to the router 15 (refer to 1-10). This response message includes the information to be employed for the next communication, such as the session ID created in Step 1-7, etc.

The router 15 converts the Global IP address of the received packet to the private IP address of the agent apparatus 12 (refer to 1-11), and transmits the response message in reply to the activation notifying message to the agent apparatus 12 (refer to 1-12).

Receiving the response message, serving as the reply to the activation notifying message, the agent apparatus 12 extracts the session ID, etc., therefrom. According to the session ID above-received, it is possible to confirm the fact that the normal connection between the agent apparatus 12 and the SaaS print service has been established. Since this session ID will be also used at the next time when transmitting the information of the printer 13, the agent apparatus 12 retains the session ID until the finalization arrives (refer to 1-13).

Completing the activation processing through the process as abovementioned, the agent apparatus 12 commences the processing for always detecting the printer 13 installed in the user's inhouse network 14, so as to notify the SaaS print service of the information of the printer 13 detected.

The abovementioned processing will be briefly described in the following. In this connection, for instance, although various kinds of protocols, such as the SSDP (Simple Service Discovery Protocol) of the UPuP (Universal Plug and Play), the WS-Discovery (Web Service Discovery), etc., can be cited as the protocol for detecting an apparatus coupled to the network, the UPuP protocol is employed in the present embodiment as a representative example of them.

The retrieving operation of the UPuP protocol is a kind of IP multicast protocol. The retriever and the retrieving object share a certain specific multicast address with each other, and the response packet is transmitted to the specific multicast address abovementioned. This IP multicast address is defined as the UPuP multicast channel. The UPuP apparatus, serving as the retrieving object, always monitors the retrieving packet. On the other hand, the retriever transmits the retrieving packet to the UPuP multicast channel. The retrieving packet includes a kind of the retrieving object (such as a printer, a camera, an AV (Audio Visual) apparatus, etc.) and a return address (such as an IP address of the retriever, etc.).

When detecting the retrieving packet from the UPuP multicast channel, the UPuP apparatus determines whether or not the content of the retrieving packet coincides with the kind of the UPuP apparatus itself. When determining that the content does not coincide with the kind of the UPuP apparatus itself, the UPuP apparatus does not issue a response, and continues to monitor the next retrieving packet. In this connection, since the IP multicast is a kind of the UDP (User Datagram Protocol), it is possible to conduct the communications between the retriever and the retrieving object, even if the connection between them, such as the TCP or the like, has not been established. However, in this case, the communications between the retriever and the retrieving object are not guaranteed due to the lack of the connection between them. As for the retrieving case abovementioned, since it is unknown for the retriever, who has transmitted the retrieving packet to the retrieving object, whether or not and when the concerned retrieving object responds to the retrieving packet, in the normal practice, the retriever receives the response packet within a certain predetermined period after transmitting the retrieving packet, while, if the retriever cannot receive the response packet within the predetermined period concerned, the retriever finalizes the retrieval processing.

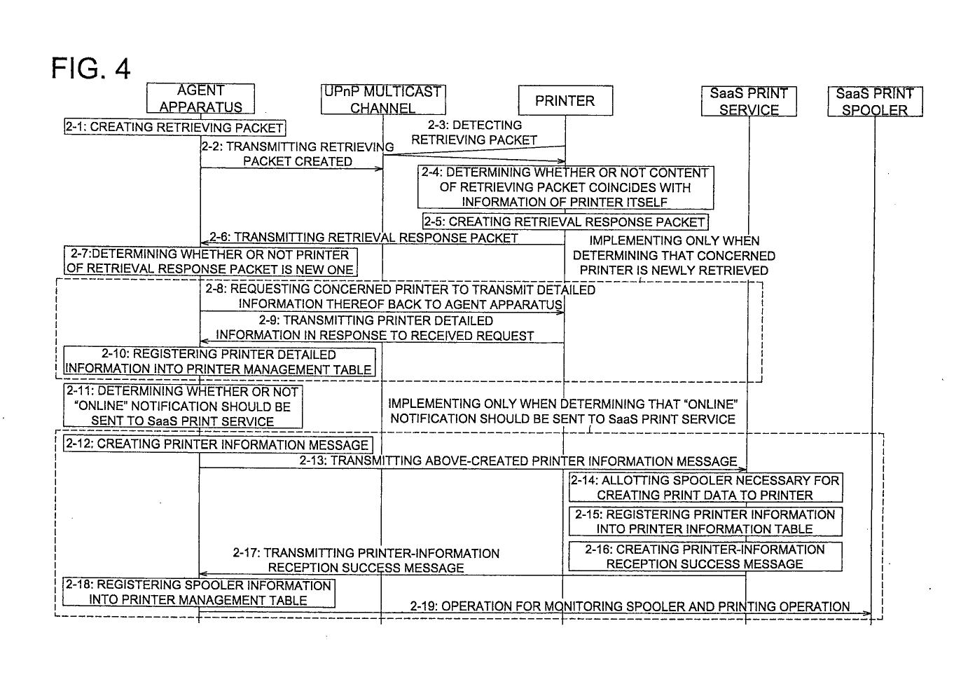

Referring to the sequential chart shown in FIG. 4, the processing for detecting the new printer and notifying the print service will be detailed in the following. In this connection, since the muter function has been indicated in the sequential chart shown in FIG. 2, the explanations for it will be omitted. Further, the processing sequence shown in FIG. 4 is repeated at predetermined intervals.

The agent apparatus 12 employs the information, in regard to a kind of the retrieving object, a desired response time, etc., to created the retrieving packet (refer to 2-1). Hereinafter, the kind of the retrieving object is established as the printer, while the address of the packet is established as the UPuP multicast channel. Successively, the agent apparatus 12 transmits the retrieving packet created in the above to the user's inhouse network 14 of the user's inhouse network system 10 (refer to 2-2).

Since the printer 13 always monitors the retrieving packet led into the UPuP multicast channel, it is possible for the printer 13 to detect the retrieving packet transmitted in Step 2-2. Then, after receiving the retrieving packet (refer to 2-3), the printer 13 determines whether or not the content of the retrieving packet coincides with the information of the printer 13 itself (refer to 2-4). In this case, since the content of the retrieving packet represents “the retrieving object is a printer”, the printer 13 determining that the concerned content coincides with the information of the printer 13 itself, and creates a retrieval response packet (refer to 2-5). The retrieval response packet above-created includes a printer ID, a URL information for acquiring the printer detailed information, an address information for accepting the print data, etc. Then, the printer 13 transmits the retrieval response packet above-created to the agent apparatus 12 through the IP Uncast (refer to 2-5).

Although the response from only a single set of printer 13 is indicated in the sequential chart shown in FIG. 4, there exists such a possibility that the plural responses will be transmitted from plural sets of printers 13, and the sequential steps after Step 2-6 will occur at the number of times being same as the number of the printers that coincide with the content of the retrieving packet. Accordingly, the agent apparatus 12 continues to receive the response within a period determined in advance. In this connection, this period is a user's settable parameter.

Receiving the retrieval response packet, the agent apparatus 12 extracts the printer ID included in the retrieval response packet concerned, in order to confirm whether or not the extracted printer ID exists in the printer management table shown in FIG. 5 (refer to 2-7). In this connection, the column of “RETRIEVAL TIME” represents the time when the retrieving packet (HTTPMU) was transmitted, so that, based on this information, the agent apparatus 12 can determines whether the concerned retrieving packet has been detected at this occasion or at the previous occasion. Then, when determining that the concerned printer ID does not exist in the printer management table, the agent apparatus 12 determines that the printer 13 currently responding is a newly installed, and request the concerned printer 13 to transmit the detailed information thereof back to the agent apparatus 12 (refer to 2-8).

In response to the request of the detailed information received from the agent apparatus 12, the printer 13 transmits the printer detailed information, including a name of manufacturer, a model name, a serial number, an available Page Description Language, a printing efficiency, etc., back to the agent apparatus 12 (refer to 2-9).

The agent apparatus 12 registers the contents of the retrieval response packet into the printer management table shown in FIG. 5, and at the same time, also registers the printer detailed information, received from the printer 13, into the printer detailed information table shown in FIG. 6 (refer to 2-10).

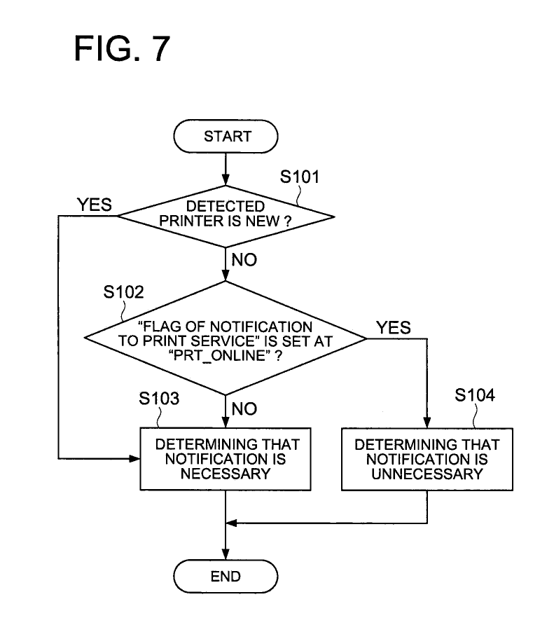

Successively, the agent apparatus 12 determines whether or not the information of the printer 13, which has sent back the retrieval response packet, should be sent to the SaaS print service as the “ONLINE” notification (refer to 2-11). Since the printer 13 is a new printer in this embodiment, the agent apparatus 12 determines that the “ONLINE” notification should be sent to the SaaS print service. On the other hand, since, sometimes, the printer is not a new printer, or the previously registered printer enters into the “ONLINE” state, even in such the case, the agent apparatus 12 determines that the “ONLINE” notification should be sent to the SaaS print service. The flow of the abovementioned “ONLINE” notification determination processing is indicated in the flowchart shown in FIG. 7. In this connection, the fact that the detected printer is not new means that the record of the concerned printer exists in the printer management table shown in FIG. 5. In that record, a column of “FLAG OF NOTIFICATION TO PRINT SERVICE” indicating either “PRT_ONLINE” or “PRT_OFFLINE” is provided, and when the concerned flag indicates the “PRT_ONLINE”, the agent apparatus 12 determines that the “ONLINE” notification should be sent.

When determining that the “ONLINE” notification should be sent, the agent apparatus 12 creates the printer information message (refer to 2-12). The printer information message includes the printer ID, the “FLAG OF NOTIFICATION TO SaaS PRINT SERVICE” indicating either “PRT_ONLINE” or “PRT_OFFLINE”, the efficiency of the printer, the session ID, etc. Successively, the agent apparatus 12 transmits the above-created printer information message to the SaaS print service (refer to 2-13).

The SaaS print service extracts the printer ID from the printer information message sent from the agent apparatus 12, so as to confirm whether or not the extracted printer ID is already registered. Concretely speaking, the SaaS print service has the printer information table shown in FIG. 8. A single printer information table exists for every agent apparatus, and retains the information of printers 13 serving under control of the corresponding agent apparatus. When the notified printer ID is not registered in the printer information table concerned, the SaaS print service determines that the printer represented by the printer ID is a new one. When determining that the printer represented by the printer ID is a new one, the SaaS print service allots a resource necessary for creating the print data to the printer 13 concerned (refer to 2-14). Hereinafter, the abovementioned resource is defined as the SaaS print spooler.

In a certain case, it is necessary to allot the resource even to a printer other than the newly detected printer. For instance, although the status of the printer 13, whose “MANAGEMENT ID” is represented by “9979” in the printer information table shown in FIG. 8, is set at “PRT_OFFLINE”, after that, when the SaaS print service receives such the notification that the status of the printer 13 concerned has changed to “PRT_ONLINE” from the agent apparatus 12, the SaaS print service again allots the SaaS print spooler suitable for the printer 13 concerned.

In this connection, the role of the SaaS print spooler will be briefly described in the following. After the document data, created by employing the SaaS document creation/editing application program, has been transferred to the SaaS print service, the concerned SaaS print service employs the printer driver application program corresponding to the printer 13 of the user's side, so as to create the print data, and transmits the created print data to the SaaS print spooler abovementioned. Accordingly, by monitoring the SaaS print spooler concerned, it is possible for the agent apparatus 12 to detect the fact that the print data has been created by the SaaS print service.

Successively, the SaaS print service registers the printer information message, received in Step 2-13, and the information in regard to the SaaS print spooler, allotted in Step 2-14, into the printer information table shown in FIG. 8 (refer to 2-15). Incidentally, a single set of printer information table is allotted to a single one of agent apparatus.

Still successively, in order to notify the agent apparatus 12 of the fact that the information of the printer 13, installed in the user's side, has been normally transmitted to the SaaS print service and the resource necessary for the printing operation is secured, the server 31 creates a printer-information reception success message (refer to 2-16). This printer-information reception success message includes information of the spooler allotted (such as the URL, etc.). Then, the sewer 31 transmits the printer-information reception success message above-created to the agent apparatus 12 (refer to 2-17).

Still successively, receiving the printer-information reception success message sent from the SaaS print service, the agent apparatus 12 extract the SaaS print spooler information therefrom. Then, the agent apparatus 12 registers the information to be used for accessing the SaaS print service into the record (column of “RECEPTION ADDRESS OF PRINT DATA” shown in FIG. 5) of the concerned printer included in the printer management table (refer to 2-18). After that, the agent apparatus 12 employs the SaaS print spooler information, so as to monitor whether or not the print data is stored within the SaaS print spooler, and, when confirming that the print data is stored, the agent apparatus 12 implements the print processing concerned (refer to 2-19).

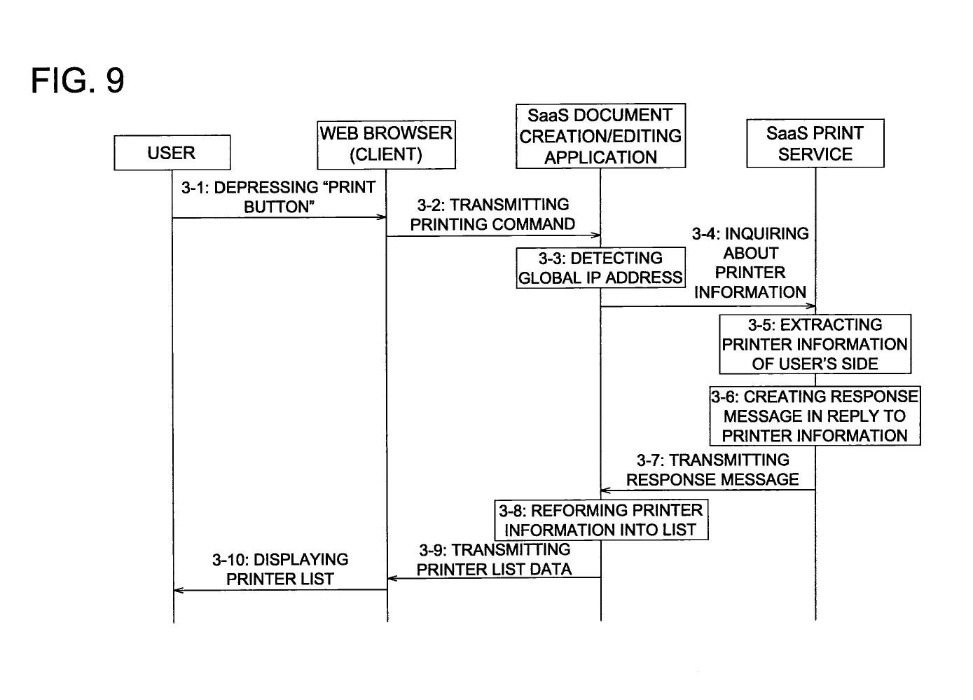

At the time of the printing operation, the OS that currently executing the SaaS document creation/editing application program has no information of the printer 13 installed in the user's side, but the SaaS print service has the information concerned. Accordingly, after receiving the printing request from the user, it is necessary for the SaaS document creation/editing application program to inquire at the SaaS print service about the information of the printer 13 installed in the user's side. Referring to the sequential chart shown in FIG. 9, the abovementioned processing will be detailed in the following

Initially, in order to print the document created by employing the SaaS document creation/editing application program, the user depresses the “PRINT BUTTON” in the menu thereof (refer to 3-1). In this connection, since the SaaS document creation/editing application program is realized in the Web browser, the abovementioned “PRINT BUTTON” is displayed as a button within the Web browser. Further, receiving the event of depressing the “PRINT BUTTON”, the Web browser transmits a printing command to the sewer 21 that provides the SaaS document creation/editing application program (hereinafter, referred to as the SaaS document creation/editing application, for simplicity) (refer to 3-2).

Successively, after receiving the printing command packet transmitted in Step 3-2, the SaaS document creation/editing application detect the Global IP address of the sender of the packet concerned (refer to 3-3). In this connection, as aforementioned, the SaaS print service employs the Global IP address for managing the information of the printer 13 installed in the user's side. Accordingly, the SaaS document creation/editing application employs the Global IP address detected in Step 3-3 for inquiring at the SaaS print service about the printer information, in order to acquire the information of the printer 13 installed in the user's side (refer to 3-4).

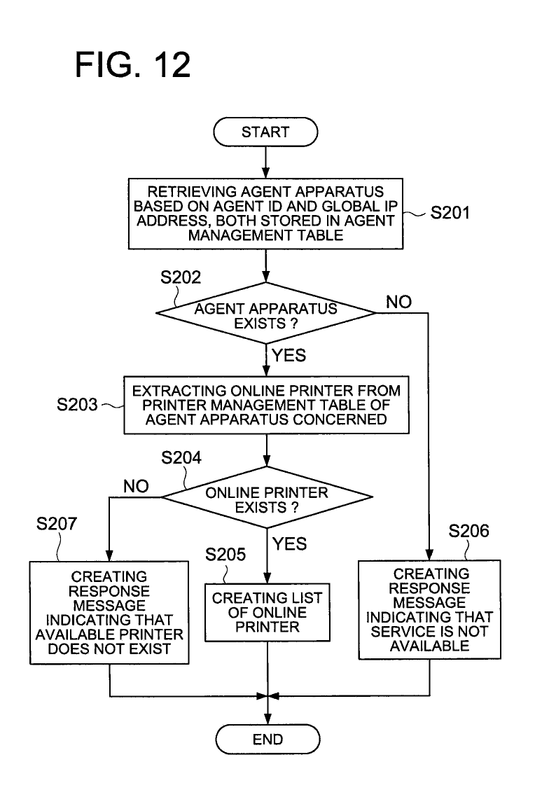

Still successively, accepting the inquiry about the printer information, the SaaS print service uses the Global IP address of the user's side, included in the inquiry message concerned, so as to extract the information of the printer 13 concerned, while referring to the agent management table shown in FIG. 3 and the printer management table shown in FIG. 8 (refer to 3-5). FIG. 12 shows a flowchart indicating the detailed flow of this extraction processing.

Still successively, the SaaS print service employs the information, extracted in Step 3-5, for creating the response message (refer to 3-6). The response message above-created includes the efficiency information such as the color, the duplex, etc., as indicated in the printer information message shown in FIG. 8, other than the printer identifier (printer ID) corresponding to each of the printers. Then, the SaaS print service transmits the response message to the SaaS document creation/editing application (refer to 3-7).

Still successively, after receiving the response message, the SaaS document creation/editing application reforms the printer information, so as to return the result to the user (refer to 3-8). For instance, although the printer ID is such the information that is indispensable for both the SaaS document creation/editing application and the SaaS print service, the printer ID is not necessary for the user. Accordingly, when reforming the list of the printer information, the SaaS document creation/editing application changes the original printer ID to such a new ID being recognizable by the user, or deletes the printer ID from the list to be displayed. Then, the SaaS document creation/editing application transmits the printer information reformed in Step 3-8 to the Web browser (refer to 3-9).

Yet successively, the Web browser depicts an image according to the message currently received, so as to display the printer list on the display (refer to 3-10).

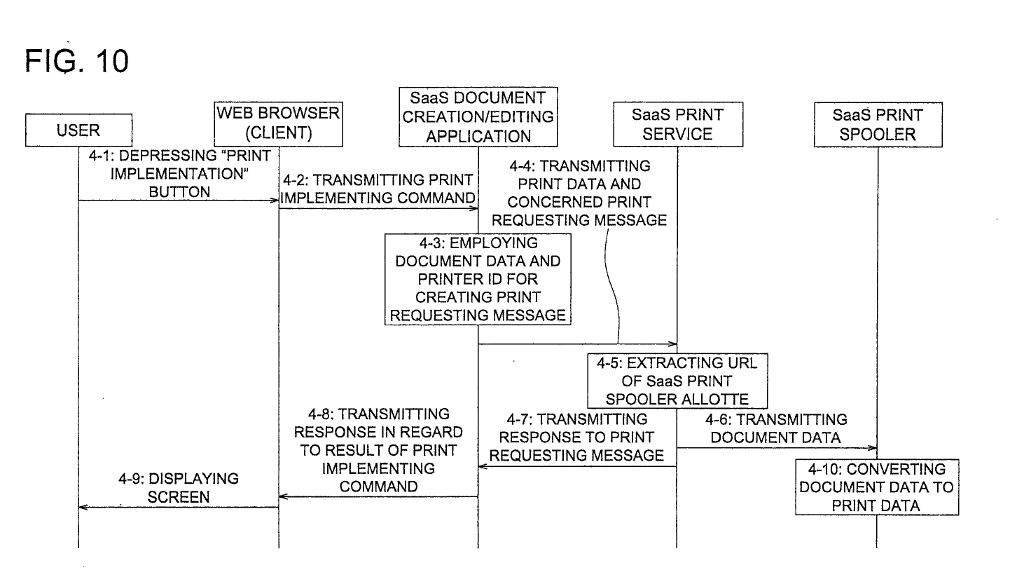

Next, referring to the sequential chart shown in FIG. 10, the processing, in which the user selects a specific printer to be employed for print outputting operations, from the printers included in the printer list displayed by the Web browser, and issues the print implementing command, will be detailed in the following.

Initially, the user selects a desired printer, which is to be employed for outputting the printout, on the screen displayed by the Web browser to conduct the print setting operation thereof and then, depresses the “PRINT IMPLEMENTATION” button after the print setting operation has been completed (refer to 4-1). Then, the Web browser transmits the printer ID for specifying the printer 13 to be employed as the outputting destination apparatus to the SaaS document creation/editing application as the print implementing command (refer to 4-2).

Successively, the SaaS document creation/editing application employs the document data internally stored and the printer ID of the outputting destination apparatus so as to create the print requesting message (refer to 4-3), and transmits the concerned print requesting message to the SaaS print service (refer to 4-4).

Still successively, receiving the print requesting message sent from the SaaS document creation/editing application, the SaaS print service extracts the printer ID therefrom. Then, by employing the printer ID above-extracted and by referring to the printer information table shown in FIG. 8, the SaaS print service extracts the URL of the SaaS print spooler allotted (refer to 4-5). Then, the SaaS print service transmits the document data and the print setting information to the SaaS print spooler concerned (refer to 4-6), and then, transmits the response to the print requesting message to the SaaS document creation/editing application, if the abovementioned processing has been normally completed (refer to 4-7).

Yet successively, according to the response sent from the SaaS print service, the SaaS document creation/editing application transmits a response in regard to the result of the print implementing command to the Web browser (refer to 4-8), so that the Web browser depicts the content of the response, so as to display it for the user concerned.

In parallel to the processing in Step 4-7, according to the contents of the print setting information, the SaaS print spooler employs the printer driver function owned by itself, or the other printer driver function owned by the other server, for converting the accepted document data to the print data (refer to 4-10). The result of the conversion processing is made to be obtainable by the agent apparatus 12 in the sequential step detailed later.

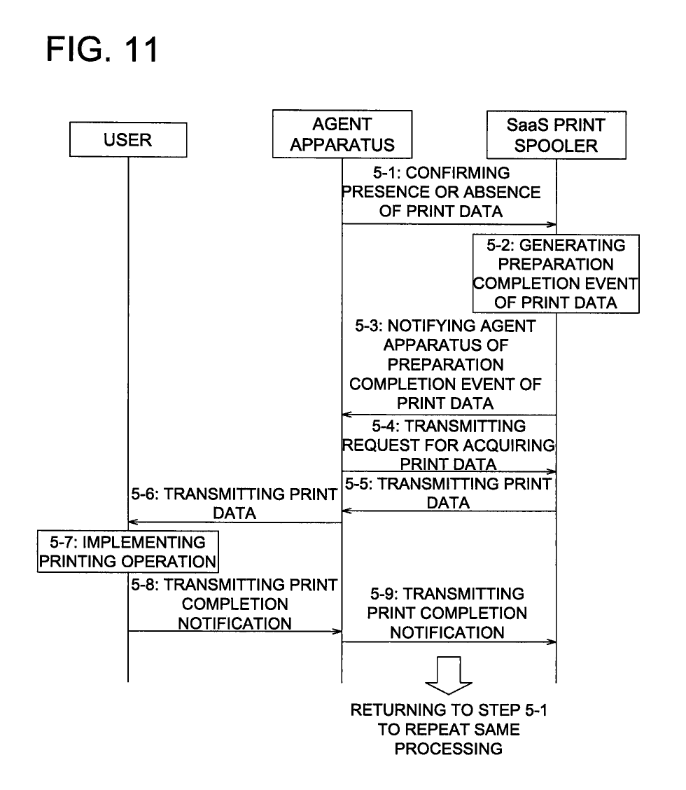

After receiving the URL of the SaaS print spooler allotted by the SaaS print service, the agent apparatus 12 establishes a persistent TCP connection with the SaaS print spooler concerned, so as to use the concerned connection for confirming the existence of the print data. When confirming that the print data exists, the agent apparatus 12 acquires the print data concerned and transmits the print data to the printer 13. Referring to the sequential chart shown in FIG. 11, the abovementioned processing will be detailed in the following.

Initially, after establishing the persistent TCP connection with the SaaS print spooler, the agent apparatus 12 confirms a presence or absence of the print data (refer to 5-1). The SaaS print spooler issues no response until the print data is generated. On the other hand, the agent apparatus 12 keeps waiting until the response arrives.

Successively, at the time when completing the preparation of the print data, serving as a printable unit, in Step 4-10 of the sequential chart shown in FIG. 10 (refer to 5-2), the SaaS print spooler notifies the agent apparatus 12 of the preparation completion event of the print data including the URL to be employed for acquiring the print data (refer to 5-3). In this connection, the printable unit is determined depending on the configuration the system that actually implements the printing operation concerned. Accordingly, the preparation completion event is generated (flagged) at such the timing of for instance, the completion of the conversion processing for all pages included in the document data, the completion of the conversion processing for a single page included in the document data, the completion of the processing for converting to print data for one scanning line, etc. In the present embodiment, the preparation completion event is generated (flagged) at the time when the conversion processing for all pages included in the document data has been completed.

Still successively, the agent apparatus 12 transmits the request for acquiring the print data to the URL included in the preparation completion event (refer to 5-4). In response to this request, the SaaS print spooler transmits the print data back to the agent apparatus 12 (refer to 5-5).

Still successively, receiving the print data, the agent apparatus 12 transmits the received print data to the printer 13, so that the printer 13 implements the printing operation based on the print data received from the agent apparatus 12 (refer to 5-7). This processing is the same as that for print data, which has been conducted by the printer driver installed in the conventional personal computer.

Yet successively, when completing the printing operation, the printer 13 transmits the print completion notification to the agent apparatus 12 (refer to 5-8), and then, receiving the print completion notification, the agent apparatus 12 transmits the print completion notification to the SaaS print spooler (refer to 5-9). After the abovementioned sequence flow has completed, the agent apparatus 12 returns to Step 5-1 so as to repeat the same processing in order to conduct the next print processing.

As described in the foregoing, according to the printing system embodied in the present invention, since the operations for managing the software to be executed on the client terminal device 11 (for instance, the operation for installing or uninstalling the printer driver corresponding to the kind of printer concerned) become unnecessary, it becomes possible to alleviate the burden to be incurred by the manager or the user. In addition, since the SaaS print service, instead of the printer driver, implements the conversion processing from the document data to the print data, even if the calculating efficiency (or capability) of the user's terminal device is low, it becomes possible for the concerned user to implement the printing operation.

Further, according to the conventional technology, the access information of the network apparatuses coupled to the user's inhouse network system has been directly transferred to the external network apparatus. On the other hand, according to the present embodiment, since no access information of the inhouse network apparatuses, coupled to the user's inhouse network system, is provided, and therefore, the inhouse network apparatuses are not directly operated from the external network, it becomes possible not only to heighten the security aspects of the user's inhouse network system, but also to protect the privacy of the user concerned.

Still further, according to the conventional technology, in order to allow the communication from the external network to the user's inhouse network system, the settings of the router should be changed, and accordingly, the change of the Firewall policy and/or a security hole have occurred. On the other hand, according to the present embodiment, since the communicating connection is to be established in a direction from the inhouse network system to the external network, it becomes unnecessary to change the settings of the router, and accordingly, it becomes possible to heighten the security aspects of the printing system.

In the foregoing descriptions, there has been exemplified such the case that the new printer is detected and the SaaS print service is notified of the new printer. However, even with respect to the printer 13 currently existing, unless the SaaS print service is notified of the status of the printer 13 concerned on a real-time base, a certain malfunction would occur.

For instance, when the power source of the printer 13 previously detected by the agent apparatus 12 is turned OFF (entered into the “OFFLINE” state), and the agent apparatus 12 has not notify the SaaS print service of the abovementioned status change of the printer 13, in response to the user's request, the SaaS print service notifies the SaaS document creation/editing application of the information of the printer 13 concerned. As a result, the user has selected the printer 13 currently entering into the “OFFLINE” state, and it would become impossible for the user to implement the actual printing operation.

Accordingly, in order to determine whether or not the concerned printer has entered into the “OFFLINE” state, the “RETRIEVAL TIME” at which the retrieval processing was implemented and the printer management table, shown in FIG. 5, are employed. The “RETRIEVAL TIME” for every printer is recorded in the printer management table shown in FIG. 5. The “RETRIEVAL TIME” represents the implementation time of the actual retrieval processing to be conducted at a predetermined period by the agent apparatus. With respect to the printer that has been once detected, the “RETRIEVAL TIME” thereof is recorded into the printer management table. Accordingly, after one cycle of the retrieval processing (including an operation for detecting a new printer, an operation for registering a detected printer into the printer management table, etc.) has been completed, if there exists such a printer, whose “RETRIEVAL TIME” at present does not coincide with the “RETRIEVAL TIME” registered at the previous occasion, among the printers recorded in the printer management table concerned, it can be determined that the status of the concerned printer has been changed.

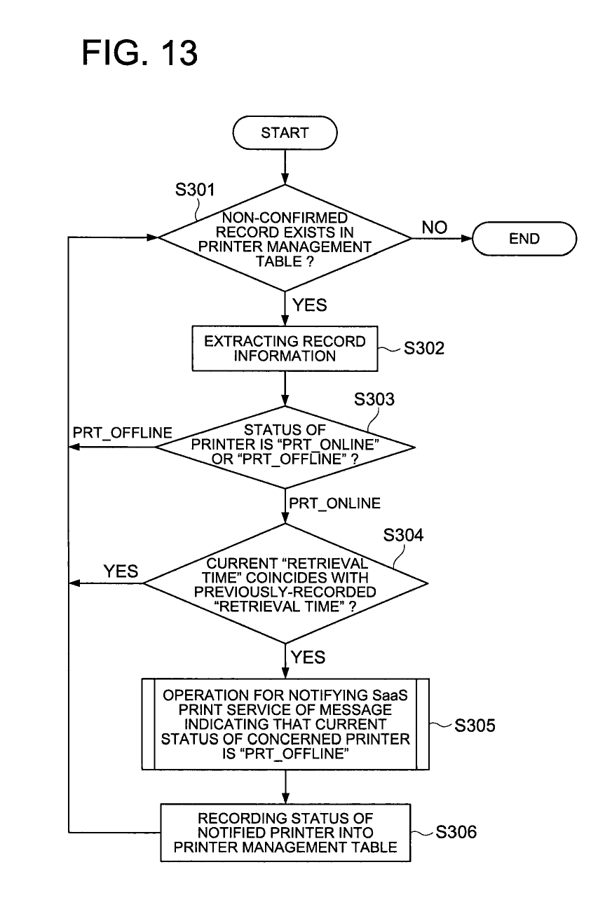

FIG. 13 shows a flowchart indicating a detailed flow of the abovementioned determination processing. This determination processing is implemented at the time when the new printer detection/notification sequential processing, shown in FIG. 4, has been completed. In this connection, although the flowchart shown in FIG. 13 exemplifies such a case that all of the records in the printer management table, shown in FIG. 5, are sequentially confirmed one by one, it is also possible to extract a specific printer, currently entering into the “OFFLINE” state, at once by using the database.

The flowchart of the determination processing, shown in FIG. 13, includes the steps of determining whether or not a non-confirmed record exists in the printer management table (Step S301); when determining that a non-confirmed record does not exist (Step S301; No), finalizing the processing, based on the indication that all of the records have been already confirmed, while, when determining that a non-confirmed record exists (Step S301; Yes), extracting the record information concerned (Step S302); determining whether the status of the printer, having the above-extracted record information, is “PRT_ONLINE” or “PRT_OFFLINE” (Step S303); when determining that the status of the printer concerned is “PRT_OFFLINE” (Step S303; PRT_OFFLINE), confirming a next record, while, when determining that the status of the printer concerned is “PRT_ONLINE” (Step S303; PRT_ONLINE), comparing the current “RETRIEVAL TIME” with the previously-recorded “RETRIEVAL TIME” (Step S304); when determining that the current “RETRIEVAL TIME” coincides with the previously-recorded “RETRIEVAL TIME” (Step S304; Yes), returning to Step S301 and confirming a next record, due to the fact that the concerned record can be recognized as the latest, while, when determining that the current “RETRIEVAL TIME” does not coincide with the previously-recorded “RETRIEVAL TIME” (Step S304; No), notifying the SaaS print service of the message indicating that the current status of the concerned printer is the “PRT_OFFLINE” (Step S305), when determined as “OFFLINE”, based on the fact that the current status of the concerned printer can be determined as the “OFFLINE”, since the concerned printer cannot be found at the current retrieval operation, though the status of the concerned printer has been determined as “ONLINE” at the previous retrieval operation; and recording the status of the notified printer into the printer management table and confirming the next record (Step S306). On the other hand, the SaaS print service records the status of the concerned printer sent from the agent apparatus 12 into the printer information table shown in FIG. 8.

Further, for instance, as another case that yield a malfunction, it would be cited that, when the power source of the printer 13, the status of which was previously noticed as “OFFLINE” to the SaaS print service, has been turned ON (“ONLINE”), and this status change of the printer 13 concerned has not been noticed to the SaaS print service, there would occur such a case that the SaaS document creation/editing application cannot make the user select the printer 13 concerned.

To overcome such the drawback, the status change of the printer 13 from the “OFFLINE” status to the “ONLINE” status is detected by the retrieval sequence to be conducted at a constant cycle by the agent apparatus 12. Step 2-11, shown in FIG. 4, represents the determination step for determining whether or not the agent apparatus 12 should notify the SaaS print service of the “ONLINE” status of the printer 13 detected in the above, and FIG. 7 shows a flowchart indicating a detailed flow of operations to be conducted in the abovementioned determination step. Initially, in Step S101, the agent apparatus 12 determines whether or not the detected printer 13 is new. This determining operation is achieved by employing the printer management table stored in the agent apparatus 12 (shown in FIG. 5), in such a manner that, when the printer ID of the detected printer 13 is already registered in the printer management table concerned, the agent apparatus 12 determines that the detected printer 13 is not new. Then, when determining that the detected printer 13 is not new (Step S101; No), the agent apparatus 12 further determines in Step S102 whether or not the “FLAG OF NOTIFICATION TO PRINT SERVICE” is set at “PRT_ONLINE”.

For instance, the printer 13, having the “MANAGEMENT ID” of “0002”, is currently registered in the printer management table shown in FIG. 5, and the “FLAG OF NOTIFICATION TO PRINT SERVICE” of the printer 13 concerned is set at “PRT_OFFLINE”. In other words, on the occasion of the previous retrieving operation, the agent apparatus 12 has notified the SaaS print service of the fact that the status of the printer 13 concerned was “OFFLINE”. If the printer 13 concerned is detected again at present, the agent apparatus 12 can recognize that the status of the printer 13 concerned has changed, and accordingly, determines in Step S103 that it is necessary to notify the SaaS print service of the “ONLINE” status of the printer 13 concerned.

By employing the method as abovementioned, it becomes possible not only to notify the SaaS print service of the status of the printer 13 under the real time base, but also to synthesize the status of the printer 13 with the SaaS side as well as the user's environment. Accordingly, since it is possible to indicate both the printer 13 being currently available and the other printer 13 being currently unavailable in a manner recognizable for the user, it becomes possible to eliminate in advance such a malfunction that the user instructs the printer 13, being currently unavailable, to implement the printing operation.

In the foregoing, the fundamental configurations of the printing system, embodied in the present invention, have been described. Further, the method for heightening the security aspects of the communication between the user's inhouse network system and the external network will be detailed in the following.

### <Encryption of Communication Data>

The SSL (Secure Socket Layer) method is employed for encrypting data to be communicated through each of various kinds of connections, including the connection between the agent apparatus 12 coupled to the user's inhouse network system and the SaaS print service, the other connection between the agent apparatus 12 coupled to the user's inhouse network system and the SaaS print spooler, still the other connection between the SaaS document creation/editing application and the SaaS print service, etc. Therefore, even if a certain third party or an intruder has stolen the data by way of a certain tapping method, it is impossible for such the injustice intruder to decrypt the data, and accordingly, it becomes possible to prevent the system from leaking the information represented by the data to be communicated.

### <User Authentication>

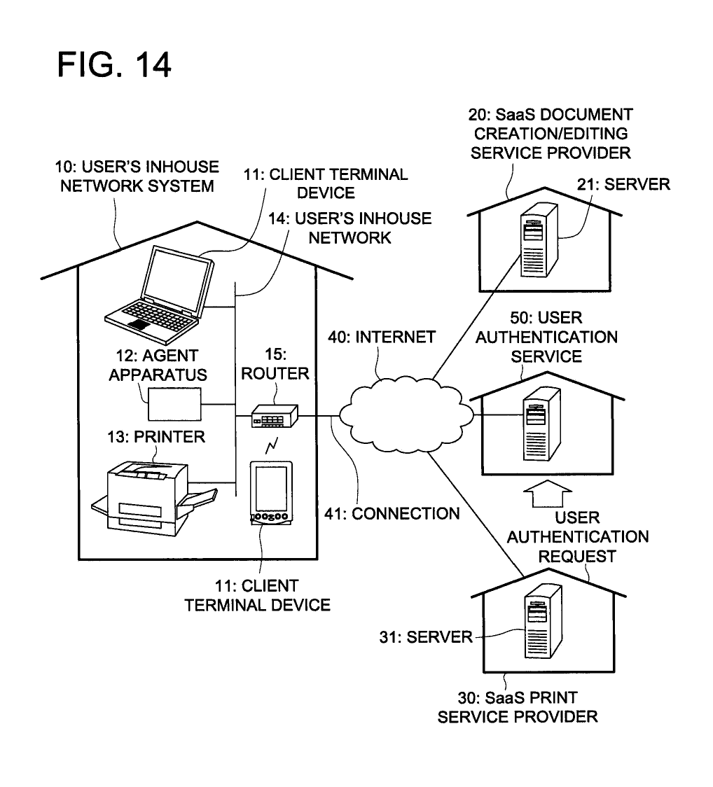

The SaaS print service provides the SaaS application, located at an external site, with the Global IP address and the print information of the user's side. Accordingly, an external user authentication service is employed for determining whether or not the SaaS application concerned is a reliable application program. FIG. 14 shows a schematic diagram indicating a system configuration to be applied to the abovementioned case. The system configuration shown in FIG. 14 includes a 50, so that the SaaS document creation/editing application and the SaaS print service respectively perform the user authentication processing in the individual base.

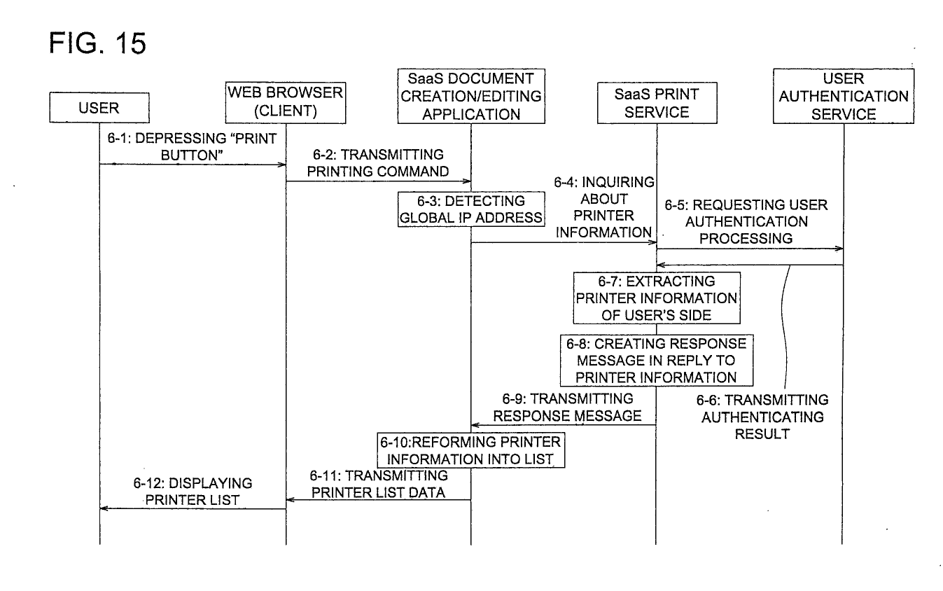

FIG. 15 shows a combined sequential chart formed by adding the user authentication processing to the sequential chart shown in FIG. 9. In Step 6-4, the SaaS document creation/editing application sends an inquiry message to the SaaS print service, in order to acquire information in regard to the printer 13 installed at the user's side. The inquiry message concerned includes the user authenticating information (for instance, a name of the user, a password). After receiving the inquiry message concerned, the SaaS print service employs the user authenticating information so as to request the user authentication service to perform the authentication processing (refer to 6-5). Further, the SaaS print service performs such the processing for transmitting the printer information to the SaaS document creation/editing application only when the user authentication service has succeeded in the authentication processing. On the other hand, when the user authentication service has failed in the authentication processing, the SaaS print service determines that the SaaS document creation/editing application is not reliable, and transmits an error message.

Further, the method for registering the information in regard to the SaaS document creation/editing application into the SaaS print service in advance is also applicable as the method for authenticating the SaaS document creation/editing application without employing the external user authentication service. The IP address, a unique identifier, etc. can be utilized as the registration information abovementioned. The SaaS print spooler employs this information to determine whether or not the printer information of the user should be provided to the SaaS document creation/editing application.

According to the abovementioned method, since it is possible to notify only such the SaaS document creation/editing application that is determined as reliable, of the information of the user's side, it becomes possible not only to heighten the security aspects of the system, but also to protect the user's privacy.

Incidentally, it is needless to say that the scope of the present invention is not limited to the embodiment exemplified in the foregoing. Modifications and additions made by a skilled person without departing from the spirit and scope of the invention shall be included in the present invention.

For instance, although the above-exemplified printing system, embodied in the present invention, is so constituted that the document data is created by employing the SaaS document creation/editing application, for instance, when the document data concerned has been created in advance, it is also applicable that the printing system is so constituted that the client terminal device 11 or the agent apparatus 12 transmits the document data to the SaaS print service, so that the SaaS print service converts the document data to the print data and sends the print data back to the agent apparatus 12. In that case, it is applicable that the SaaS print service makes the user select the desired printer, and employs the printer driver application program, corresponding to the printer selected by the user, for converting the document data to the print data.

The present invention is available for such a printing system in which print data is created by using the service provided by a service provider, so that a printer installed in a user's inhouse network system employs the print data to implement the printing operation.

According to the printing system embodied in the present invention, it becomes possible even for a client, who has no document creation/editing application program and no printer driver, to implement a printing operation easily and safely by employing the SaaS.

This is because, the print support apparatus (print support program), which is to be installed in a user's inhouse network being connectable to an Internet, is provided with: a detecting function for detecting a printer coupled to the user's inhouse network; a notifying function for notifying a print service server of information for specifying the printer detected by the detecting function; an acquiring function for accessing a predetermined storing destination site, in which print data created from document data by the print service server by executing a printer driver corresponding to the printer detected by the detecting function, is stored, so as to acquire the print data from the predetermined storing destination site concerned; and a data transferring function for transferring the print data, acquired by the acquiring function, to the printer detected by the detecting function.

As described in the foregoing, according to the printing system embodied in the present invention, since it becomes unnecessary to provide the document creation/editing application program and/or the printer driver in the user's inhouse network system side, it becomes possible to omit the operations for installing the abovementioned programs or the like, resulting in improvements of user's convenience and usability. In addition, it also becomes unnecessary to introduce a high performance terminal device into the user's inhouse network system, and it becomes possible to widen the range of client terminal devices available for the user's inhouse network system. Further, since a legacy printer is also available as the printer to be installed in the user's side, it becomes possible to easily achieve the cost reduction of the printing system concerned, and make it easy to employ the SaaS.

While the preferred embodiments of the present invention have been described using specific term, such description is for illustrative purpose only, and it is to be understood that changes and variations may be made without departing from the spirit and scope of the appended claims.

What is claimed is:

1. A print support apparatus that is to be installed in a user's inhouse network being connectable to the Internet, comprising:
a detecting section to detect a printer coupled to the user's inhouse network;
a notifying section to notify a print service server, provided with a printer driver function, of information for specifying the printer detected by the detecting section;
an acquiring section that accesses a predetermined storing destination site, in which print data created from document data by the print service server by executing a printer driver corresponding to the printer detected by the detecting section, is stored, so as to acquire the print data from the predetermined storing destination site concerned; and
a data transferring section to transfer the print data, acquired by the acquiring section, to the printer detected by the detecting section.

2. The print support apparatus of claim 1,
wherein the detecting section monitors a status of the printer coupled to the user's inhouse network, and when the detecting section detects a status change of the printer, the notifying section notifies the print service server of the status change of the printer.

3. A printing system, comprising:
a print service server that is provided with a printer driver function; and
a user's inhouse network that is provided with a printer and a print support apparatus, and that is coupled to the print service server through the Internet;
wherein the print service server creates print data from document data by executing a printer driver corresponding to the printer, so as to store the print data above-created into a predetermined storing destination site; and
wherein the print support apparatus comprises:
a detecting section to detect the printer coupled to the user's inhouse network;
a notifying section to notify a print service server of information for specifying the printer detected by the detecting section;
an acquiring section that accesses the predetermined storing destination site so as to acquire the print data therefrom; and
a data transferring section to transfer the print data acquired by the acquiring section to the printer detected by the detecting section.

4. The printing system of claim 3,
wherein the print support apparatus monitors a status of the printer coupled to the user's inhouse network, and when detecting a status change of the printer, the print support apparatus notifies the print service server of the status change of the printer.

5. A printing system, comprising:
a document creation/editing service server that makes it possible for a user to create document data on a Web browser,
a print service server that is provided with a printer driver function; and
a user's inhouse network that is provided with a client terminal device, a printer and a print support apparatus;
wherein the document creation/editing service server, the print service server and the user's inhouse network are coupled to each other through the Internet; and
wherein the print service server comprises:
a printer-information notifying section to notify the document creation/editing service server of information for specifying the printer coupled to the user's inhouse network;
a data acquiring section to acquire the document data and the information for specifying the printer selected from plural printers, which are coupled to the user's inhouse network, from the document creation/editing service server; and
a print-data creation/storing section that creates print data from the document data by executing a printer driver corresponding to the printer selected, so as to store the print data into a predetermined storing destination site; and
wherein the print support apparatus comprises:
a detecting section to detect the printer coupled to the user's inhouse network;
a notifying section to notify the print service server of the information for specifying the printer detected by the detecting section, through the Internet;
an acquiring section that accesses the predetermined storing destination site, so as to acquire the print data, created from the document data by executing the printer driver corresponding to the printer selected, from the predetermined storing destination site; and
a data transferring section to transfer the print data acquired by the acquiring section to the printer selected.

6. The printing system of claim 5,
wherein, when receiving a print instruction command sent from the client terminal device, the document creation/editing service server employs a Global IP address of the print instruction command for sending an inquiry to the print service server about printer information; and
wherein, when receiving the inquiry, the print service server notifies the document creation/editing service server of the printer information in regard to specific printers managed by correlating with the Global IP address; and
wherein, when receiving the printer information sent from the print service server, the document creation/editing service server displays a list of the specific printers correlating with the Global IP address onto a screen of the Web browser, so as to make it possible for the user to select one of the specific printers, which actually implements a printing operation.

7. The printing system of claim 5,
wherein the print support apparatus monitors a status of the printer coupled to the user's inhouse network, and when detecting a status change of the printer, the print support apparatus notifies the print service server of the status change of the printer.

8. A non-transitory computer readable storage medium storing a computer executable program to be executed in an apparatus, installed in a user's inhouse network being connectable to the Internet, for supporting a printing operation to be implemented in a printing system, the program being executable by a computer to cause the computer to perform a process comprising:
detecting a printer coupled to the user's inhouse network;
notifying a print service server, provided with a printer driver function, of information for specifying the printer detected;
accessing a predetermined storing destination site, in which print data created from document data by the print service server by using a printer driver corresponding to the printer detected, is stored, so as to acquire the print data from the predetermined storing destination site; and
transferring the print data to the printer.

9. The non-transitory computer readable storage medium of claim 8, the process further comprising:
monitoring a status of the printer coupled to the user's inhouse network; and
notifying the print service server of a status change of the printer when detecting the status change of the printer currently monitored.
